(19) United States
(12) Patent Application Publication
(10) Pub. No.: US 2006/0030670 A1
(43) Pub. Date: Feb. 9, 2006

(54) Graft polymer and method of preparing the same

(76) Inventors: Hyoung-Oh Lee, Suwon-si (KR); Cheon-Shik Byun, Suwon-si (KR); Kyung-Hwan Kim, Seoul (KR)

Correspondence Address: MAYER, BROWN, ROWE & MAW LLP, 1909 K STREET, N.W., WASHINGTON, DC, 20006, US

(21) Appl. No.: 11/023,394

(22) Filed: Dec. 29, 2004

(30) Foreign Application Priority Data
Aug. 3, 2004 (KR) 10-2004-0068507

(51) Int. Cl. C08F 297/02

(52) U.S. Cl. 525/242

(57) ABSTRACT

In a graft polymer and a method of preparing the graft polymer, polycarboxylic acid is polymerized from unsaturated carboxylic acid according to the following reaction equation (2). Then, an esterification reaction of polycarboxylic acid and polyoxyalkylene glycol is conducted according to the following reaction equation (3). Thus obtained graft polymer has a good dispersing property.

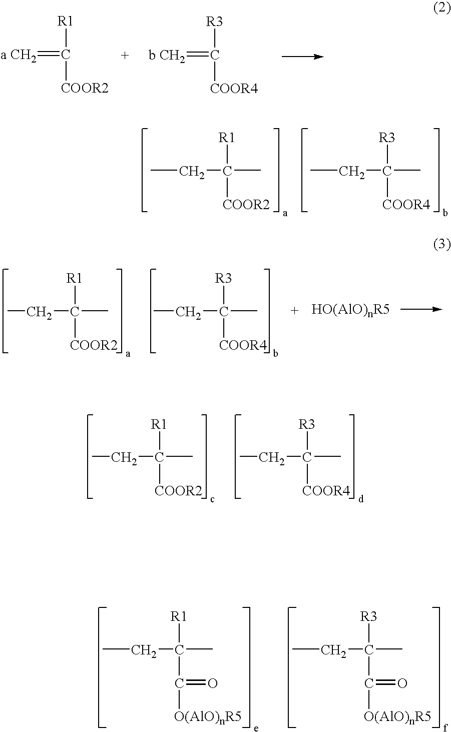

In the above formulae, R₁ and R₃ independently represent a hydrogen atom or a methyl group, R₂ and R₄ independently represent a hydrogen atom or a hydrocarbon group having 1 to 30 carbon atoms, at least one of R₂ and R₄ being the hydrogen atom, (-A1O—) represents an oxyalkylene unit having 2 to 4 carbon atoms, (-A1O—) having one kind of the oxyalkylene unit, or being a combination of two or more kinds of the oxyalkylene units, n represents an average unit number of the oxyalkylene unit and is an integer of 1 to 100, R₅ represents a hydrogen atom or a hydrocarbon group having 1 to 30 carbon atoms, and c, d, e and f represent mol ratios of repeating unit constituting the graft polymer, a value of c+d+e+f being larger than 0 and a value of d+f being 0 to 0.5.

### CROSS REFERENCE TO RELATED APPLICATION

This application claims priority under 35 USC § 119 to Korean Patent Application No. 2004-68507 filed on Aug. 30, 2004, the content of which is incorporated herein by reference in its entirety.

### BACKGROUND OF THE INVENTION

1. Field of the Invention

The present invention relates to a graft polymer and a method of preparing the graft polymer. More particularly, the present invention relates to a graft polymer that can be used as a water reducing agent for cement and a method of preparing the graft polymer.

2. Description of the Related Art

Concrete includes cement as binder, sand and gravel. In order to mix previously mentioned components smoothly, water is added, and thus mixed concrete is poured and cast at a construction field before hardening. The concrete is hardened at active sites of clinker particles of the cement through the hydration reaction between tricalcium silicate (Ca₃SiO₅; C₃S in short) and water.

When a large amount of water is added into unhardened concrete, the hydration reaction between water and the cement is promoted to harden the concrete before moving to the construction field. Accordingly, a working efficiency is lowered and the durability of the concrete is considerably weakened. In order to prevent the above-mentioned phenomena, the added amount of water should be reduced and a water reducing agent is added into the cement.

An ether-based graft polymer is used as the water reducing agent for the cement and concrete. Among the ether-based graft polymer, copolymers having good efficiency are disclosed in Korean Patent Laid-open Publication Nos. 1993-17839, 1997-65574 and 2000-6263 disclose. The copolymers (hereinafter, will be frequently called by ester-based graft polymer) are prepared from an alkylene oxide added product of unsaturated alcohol including allyl alcohol, methallyl alcohol, 1,1-dimethyl-2propenyl alcohol or 3-methyl-3-butenyl alcohol, and unsaturated carboxylic acid including maleic acid, anhydrous maleic acid, acrylic acid or methacrylic acid.

However, since the polymerization degree of the ether-based graft polymer from the monomer is relatively low, an application of the polymer to a highly sensitive work having a low water/cement ratio is limited. In particular, an excessive retardation of the coagulation of the concrete may be generated according to the used amount of the polymer.

A copolymer of alkylene oxide added monomer of acrylic acid or methacrylic acid, and unsaturated carboxylic acid including acrylic acid or methacrylic acid is disclosed In Korean Patent Laid-open Publication Nos. 1988-1547, 1994-6960, 1999-68043 and 2001-50216, as a water reducing agent applicable to the highly sensitive work having the low water/cement ratio. However, since almost 100% of the monomer is polymerized to the ester-based graft polymer, the polymer efficiency is largely affected by a small quality change of the monomer.

For the ester-based graft polymer, the quality of the monomer obtained by adding alkylene oxide into acrylic acid or methacrylic acid determines the quality of thus synthesized ester-based graft polymer. Therefore, the quality of the alkylene oxide added product that is the raw material of the monomer is also required to be good. Here, residual moisture before adding alkylene oxide largely deteriorates the quality of thus prepared monomer.

That is, the preparing condition of the monomer and the preparing condition of the raw material of the monomer should be strictly managed for the ester-based graft polymer. However, the confirmation of the quality of the monomer and the raw material of the monomer based on general standard of physical properties is impossible before conducting the polymerization of the ester-based graft polymer. Accordingly, the quality of the raw material of each lot should be confirmed by an experimental polymerization before a mass production to prevent the production of the polymer having deteriorated quality.

### SUMMARY OF THE INVENTION

The present invention provides a graft polymer having good dispersing property.

The present invention also provides a method of preparing a graft polymer having good dispersing property while minimizing an effect due to quality of raw materials.

In accordance with one aspect of the present invention, a graft polymer is represented by the following chemical formula (1).

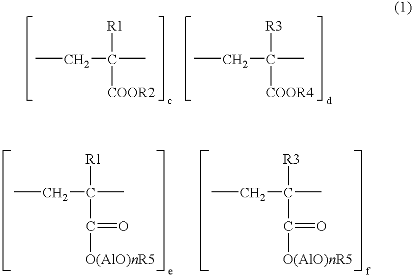

In the chemical formula (1), R₁ and R₃ independently represent a hydrogen atom or a methyl group, R₂ and R₄ independently represent a hydrogen atom or a hydrocarbon group having about 1 to 30 carbon atoms. Here, at least one of R₂ and R₄ is the hydrogen atom. (-A1O—) represents an oxyalkylene unit having about 2 to 4 carbon atoms, and (-A1O—) may have one kind of the oxyalkylene unit or may be a combination of two or more kinds of the oxyalkylene units, n represents an average molar number of the oxyalkylene unit and is an integer of 1 to 100, R₅ represents a hydrogen atom or a hydrocarbon group having about 1 to 30 carbon atoms, and c, d, e and f independently represent mol ratios of repeating unit constituting the polymer. The value of c+d+e+f is larger than 0 and the value of d+f is 0 to 0.5. Here, the graft polymer preferably has a melt viscosity of about 100 cps to about 50000 cps at a temperature of about 80° C.

In accordance with another aspect of the present invention, there is provided a method of preparing a graft polymer. Polycarboxylic acid is firstly prepared by polymerizing unsaturated carboxylic acid and then, an esterification reaction is conducted using thus obtained polycarboxylic acid and polyoxyalkylene glycol to prepare a graft polymer having a melt viscosity of about 100 cps to about 50000 cps at a temperature of about 80° C.

In one embodiment of the present invention, polycarboxylic acid is prepared by polymerizing unsaturated carboxylic acid according to the reaction equation (2). Then, an esterification reaction is conducted using the polycarboxylic acid and polyoxyalkylene glycol according to the reaction equation (3) to give a graft polymer having a melt viscosity of about 100 cps to about 50000 cps at a temperature of 80° C.

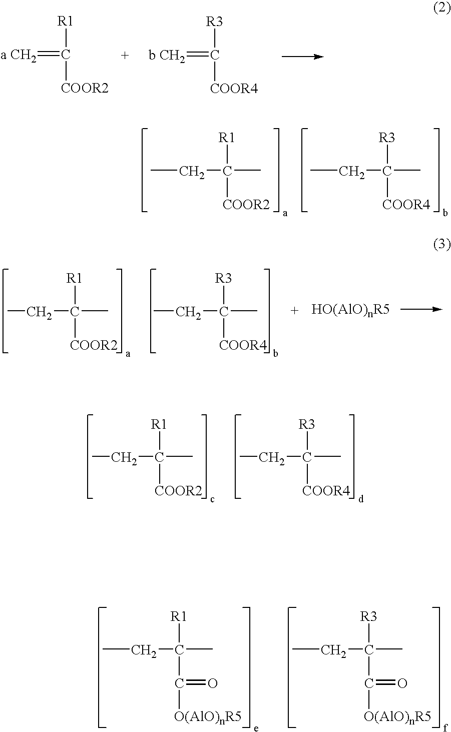

In the reaction equations (2) and (3), R₁ and R₃ independently represent a hydrogen atom or a methyl group, and R₂ and R₄ independently represent a hydrogen atom or a hydrocarbon group having 1 to 30 carbon atoms. Here, at least one of R₂ and R₄ is the hydrogen atom, (-A1O—) represents an oxyalkylene unit having 2 to 4 carbon atoms and (-A1O—) may have one kind of the oxyalkylene unit or may be a combination of two or more kinds of the oxyalkylene units, n represents an average molar (or unit) number of the oxyalkylene unit and is an integer of 1 to 100, R₅ represents a hydrogen atom or a hydrocarbon group having 1 to 30 carbon atoms, and a, b, c, d, e and f represent mol ratios of repeating unit constituting of the polymer. The value of a+b is larger than 0, c+e=a, d+f=b and the value of b is 0 to 0.5.

The step of preparing the polycarboxylic acid is carried out at a temperature of about 80° C. to about 170° C. under a pressure of about 5 atm or less. Azo-based catalyst can be used as a polymerizing catalyst. The step of preparing a water reducing agent is carried out at a temperature of about 80° C. to about 150° C. and an acid catalyst such as para-toluene sulfonic acid can be used as an esterification catalyst. The esterification reaction is proceeded until the melt viscosity of the graft polymer becomes about 100 cps to about 50000 cps at a temperature of about 80° C. Here, a vacuum dehydration process also can be performed along with the esterification reaction.

In another embodiment of the present invention, the polycarboxylic acid is prepared in the presence of an acid catalyst. Thus, preparation of the polycarboxylic acid and the esterification reaction of the polycarboxylic acid and the polyoxyalkylene glycol are simultaneously carried out.

According to the present invention, a graft polymer is prepared through an esterification reaction of polycarboxylic acid prepared from unsaturated carboxylic acid and polyoxyalkylene glycol. Here, the reaction is stopped before the melt viscosity of the ester-based graft polymer is excessively increased by controlling the reaction degree according to the reaction time. Thus, the quality change of the graft polymer according to the quality change of raw materials can be minimized so that the cement slurry having similar dispersing property with a conventional water reducing agent prepared by polymerizing an ester-based graft monomer and unsaturated carboxylic acid can be manufactured. In addition, utility cost concerning an excessive solvent reflux can be reduced by applying a vacuum dehydration process during the esterification reaction.

### DESCRIPTION OF THE INVENTION

The present invention now will be described more fully hereinafter. The present invention may, however, be embodied in many different forms and should not be construed as limited to the embodiments set forth herein; rather, these embodiments are provided so that this disclosure will be thorough and complete, and will fully convey the scope of the invention to those skilled in the art.

Graft Polymer

In the present invention, the graft polymer is represented by the following chemical formula (1).

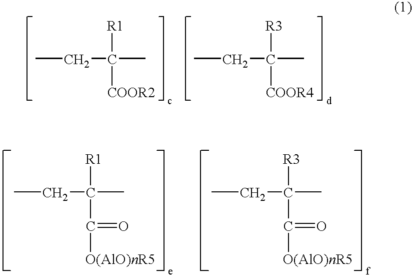

In the formula (1), R₁ and R₃ independently represent a hydrogen atom or a methyl group, and R₂ and R₄ independently represent a hydrogen atom or a hydrocarbon group having 1 to 30 carbon atoms. Here, each of R₂ and R₄ preferably represents a hydrogen atom or a hydrocarbon group having 1 to 6 carbon atoms and more preferably, is one of a methyl group, an ethyl group and a butyl group. (-A1O—) represents an oxyalkylene unit having 2 to 4 carbon atoms and (-A1O—) may have one kind of the oxyalkylene unit or may be a combination of two or more kinds of the oxyalkylene units, n represents an average molar number of the oxyalkylene unit and is an integer of 1 to 100, R₅ represents a hydrogen atom or a hydrocarbon group having 1 to 30 carbon atoms, and c, d, e and f represent mol ratios of repeating unit constituting the polymer. The value of c+d+e+f is larger than 0. The value of d+f is 0 to 0.5 and more preferably, is 0.05 to 0.3. Here, the graft polymer preferably has a melt viscosity of about 100 cps to about 50000 cps at a temperature of about 80° C. Within the preferred viscosity range, the graft polymer exhibits a good dispersing property.

The quality of the cement slurry manufactured using the graft polymer according to the present invention is rarely affected by the quality of the monomer. In addition, the cement slurry of the present invention exhibits almost equal dispersing property when comparing with that of the conventional cement slurry.

Method of Preparing Graft Polymer

According to one embodiment of the present invention, polycarboxylic acid is prepared by polymerizing unsaturated carboxylic acid according to the reaction equation (2) as follows.

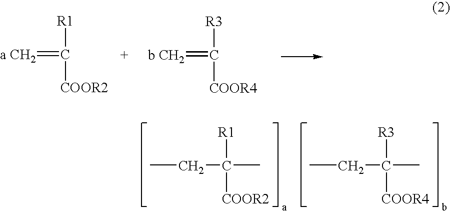

In the reaction equation (2), R₁ and R₃ independently represent a hydrogen atom or a methyl group, and R₂ and R₄ independently represent a hydrogen atom or a hydrocarbon group having 1 to 30 carbon atoms. Here, each of R₂ and R₄ preferably represents a hydrogen atom or a hydrocarbon group having 1 to 6 carbon atoms, and more preferably, is one of a methyl group, an ethyl group and a butyl group. At least one of R₂ and R₄ is the hydrogen atom, and a and b represent mol ratios of repeating unit constituting the polymer. The value of a+b is larger than 0 and the value of b is 0 to 0.5 and, preferably 0.05 to 0.3.

An azo-based catalyst may be used as a polymerizing catalyst. The polycarboxylic acid polymer constituting the ester-based graft polymer may include a polymethacrylic acid homopolymer, a polyacrylic acid homopolymer or a copolymer of methacrylic acid and acrylic acid, and can be advantageously polymerized using a solvent having a low boiling point such as water, isopropyl alcohol, etc. However, during dehydration or de-solvation for conducting an esterification reaction of the polycarboxylic acid and the polyoxyalkylene glycol, polycarboxylic acid polymer is precipitated and carbonated so that the processing of the esterification reaction becomes substantially impossible. In addition, when the esterification reaction is continuously proceeded, water-insoluble gel is produced. This phenomenon is even further seriously generated when an inorganic-based catalyst such as sodium persulfate is used as the polymerizing catalyst.

When an organic peroxide catalyst is used, the compatibility of the polycarboxylic acid polymer and the polyoxyalkylene glycol is somewhat improved, however, a portion of the polyoxyalkylene glycol is oxidized and decomposed to deteriorate the quality of the ester-based graft polymer. Therefore, for the preparation of polycarboxylic acid, the azo-based catalyst that generates nitrogen (N₂) gas during decomposition is used as the polymerizing catalyst to minimize the oxidation and decomposition of the polyoxyethylene glycol functioning as a self-polymerizing solvent or a diluting agent, and to confirm the compatibility of the polycarboxylic acid and the polyoxyalkylene glycol.

In the method of preparing the graft polymer according to the present invention, when the polymerizing temperature of the polycarboxylic acid exceeds about 170° C., the azo-based catalyst is violently decomposed to induce a local explosion, thereby unstabilizing a reaction vessel. In addition, the monomer component making azeotrope with the solvent is condensed and a thermal polymerization is induced when the monomer component flows along the surface of the reaction vessel. Here, washing the reaction vessel becomes difficult due to the condensed component attached on the surface of the reaction vessel.

Further, the component of the designed polycarboxylic acid may be altered. On contrast, when the polymerizing temperature of polycarboxylic acid is below about 80° C. during preparing the graft polymer according to the present invention, the molecular weight of the polycarboxylic acid polymer is augmented. Here, the compatibility with polyoxyalkylene glycol is rapidly deteriorated to form precipitation as a coagulated material. In addition, the evaporation of added solvent such as isopropyl alcohol, tertiary butyl alcohol and the like becomes difficult to retard the esterification reaction, which might proceed along with the polymerization. Further, the removal of water present in the reaction vessel is difficult to promote the corrosion of the reaction vessel and to deteriorate the color of the polymer. Therefore, the preferred polymerizing temperature of polycarboxylic acid is in the range of about 80° C. to about 170° C., and more preferably in the range of about 110° C. to about 160° C.

In the method of preparing the graft polymer according to the present invention, the polymerizing temperature of the polycarboxylic acid is firstly determined according to the glass transition temperature (Tg) of the polycarboxylic acid. That is, the polymerization is preferably carried out at the glass transition temperature (Tg) of the polycarboxylic acid or over, and more preferably, the polymerizing reaction is implemented at the temperature higher than the glass transition temperature of the polycarboxylic acid by about 10° C. to about 50° C.

In particular, the glass transition temperature (Tg) of the polymethacrylic acid homopolymer is about 228° C., the glass transition temperature (Tg) of the polyacrylic acid homopolymer is about 106° C., and the glass transition temperature (Tg) of the copolymer of methacrylic acid and acrylic acid is about 106° C. to about 228° C. depending on the component ratio of methacrylic acid and acrylic acid. Here, since the glass transition temperature (Tg) of the polymethacrylic acid polymer is particularly high, 0 to 50 mol % of methyl acrylate, ethyl acrylate, butyl acrylate, methyl methacrylate and the like based on the weight amount of methacrylic acid is copolymerized to lower the glass transition temperature of the polycarboxylic acid polymer. When the copolymerizing amount of methyl acrylate, ethyl acrylate, butyl acrylate, methyl methacrylate and the like exceeds 50 mol % based on the weight amount of methacrylic acid, the dispersing property of the graft polymer is relatively lowered. Accordingly, in the reaction equation (1), the preferred value of b is about 0 to about 0.5, and more preferably the value of b is about 0.05 to about 0.3.

As the amount of the polymethacrylic acid increases, the glass transition temperature (Tg) of the polycarboxylic acid is increased. In order to lower the polymerizing temperature, about 0 to about 20% by weight of a solvent having a good compatibility with the polycarboxylic acid and the polyoxyalkylene glycol such as isopropyl alcohol, tertiary butyl alcohol, and the like is used based on the weight amount of polyoxyalkylene glycol. Simultaneously, polycarboxylic acid can be polymerized at the temperature lower than the glass transition temperature (Tg) of the polycarboxylic acid, that is, lower than about 170° C. through applying a total reflux or a partial reflux. When the amount of the solvent such as isopropyl alcohol and tertiary butyl alcohol exceeds about 20% by weight of the polyoxyalkylene glycol, excessive side reaction of the solvent occurs for tertiary butyl alcohol. In addition, keeping undesirably excessive pressurizing state may be required for keeping the high polymerizing temperature.

In the method of preparing the graft polymer of the present invention, the preferred polymerizing pressure of the polycarboxylic acid is less than 5 atm, more preferably, the polymerizing pressure is about 3 atm or less. When the polymerizing pressure exceeds about 5 atm, the polymerizing reaction of polycarboxylic acid may not be smoothly carried out and undesirable application of the excessive pressure may be necessary.

An esterification reaction of the polycarboxylic acid and the polyoxyalkylene glycol is then carried out according to the following reaction equation (3) to prepare the graft polymer.

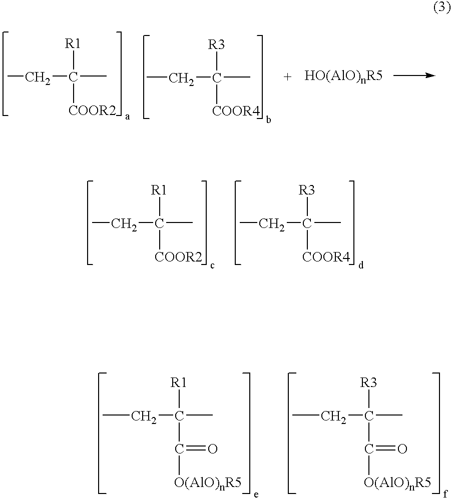

In the reaction equation (3), R₁ and R₃ independently represent a hydrogen atom or a methyl group, and R₂ and R₄ independently represent a hydrogen atom or a hydrocarbon group having 1 to 30 carbon atoms. Here, each of R₂ and R₄ preferably is the hydrocarbon group having 1 to 6 carbon atoms and more preferably, is one of a methyl group, an ethyl group and a butyl group. At least one of R₂ and R₄ is the hydrogen atom. (-A1O—) represents an oxyalkylene unit having 2 to 4 carbon atoms and (-A1O—) may have one kind of the oxyalkylene unit or may be a combination of two or more kinds of oxyalkylene units, n represents an average molar number of the oxyalkylene unit and is an integer of 1 to 100, R₅ represents a hydrogen atom or a hydrocarbon group having 1 to 30 carbon atoms, and a, b, c, d, e and f represent mol ratios of repeating unit constituting the polymer. The value of a+b is larger than 0, c+e=a, d+f=b, and the value of b is 0 to 0.5, and preferably is 0.05 to 0.3.

During conducting the polymerization reaction, an acid catalyst of the esterification reaction such as para-toluene sulfonic acid may be used. Accordingly, the esterification reaction of the polycarboxylic acid and the polyoxyalkylene glycol can be more smoothly conducted.

When the temperature of the esterification reaction during preparing the graft polymer according to the present invention is lower than about 80° C., the esterification reaction is excessively retarded. When the temperature of the esterification exceeds about 150° C., the decomposition of polyoxyethylene glycol is undesirably promoted. Therefore, the esterification reaction is preferably conducted at the temperature of about 80° C. to about 150° C. and more preferably at the temperature of about 120° C. to about 150° C.

According to one embodiment of the present invention, a vacuum dehydration reaction may be simultaneously conducted along with the esterification reaction. Therefore, utility cost due to the solvent added for the esterification reaction or an ester exchange reaction and due to the excessive reflux of the solvent to promote the reaction may be reduced.

In the method of preparing the graft polymer according to the present invention, the esterification reaction is preferably ended when the melt viscosity of the graft polymer becomes about 100 cps to about 50000 cps at a temperature of about 80° C. More preferably, the reaction is ended when the melt viscosity of the graft polymer is about 110 cps to about 15000 cps. The melt viscosity of the graft polymer can be controlled by a method using an In-Line viscometer, a method using a torque meter, a method of monitoring the change of the load current or load voltage of the stirrer, etc. Thus, a graft polymer having the same dispersing property with the water reducing agent obtained by the conventional method may be prepared.

According to another embodiment of the present invention, polycarboxylic acid is prepared by polymerizing unsaturated carboxylic acid according to the following reaction equation (2) and at the same time, an esterification reaction of polycarboxylic acid with polyoxyalkylene glycol is partially carried out.

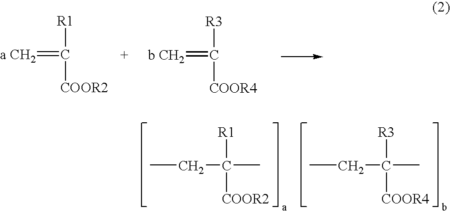

In the reaction equation (2), R₁ and R₃ independently represent a hydrogen atom or a methyl group, and R₂ and R₄ independently represent a hydrogen atom or a hydrocarbon group having 1 to 30 carbon atoms. Here, each of R₂ and R₄ preferably is a hydrocarbon group having 1 to 6 carbon atoms and more preferably, is one of a methyl, group, an ethyl group, and a butyl group. At least one of R₂ and R₄ is the hydrogen atom. a and b represent mol ratios of repeating unit constituting the polymer, the value of a+b is larger than 0 and the value of b is 0 to 0.5, and more preferably, the value of b is 0.05 to 0.3.

In the method of preparing the graft polymer according to the present invention, an azo-based catalyst and an acid catalyst such as para-toluene sulfonic acid may be used as a polymerizing catalyst. Here, the azo-based catalyst may be used for polymerization and the acid catalyst may be used for esterification. During the polymerizing reaction of polycarboxylic acid, an acid catalyst such as para-toluene sulfonic acid is added along with the azo-based catalyst so that the partial esterification of polycarboxylic acid and polyoxyalkylene glycol and the polymerization of polycarboxylic acid are carried out at the same time. As a result, even better compatibility of polycarboxylic acid with polyoxyalkylene glycol may be obtained.

Accordingly, the azo-based catalyst generating nitrogen (N₂) gas during decomposing may be used as the polymerizing catalyst during preparing polycarboxylic acid to thereby minimize an oxidation decomposition of polyoxyethylene glycol functioning as a polymerizing solvent or a diluting agent. In addition, a good compatibility of polycarboxylic acid and polyoxyalkylene glycol can be confirmed through the application of the esterification catalyst such as para-toluene sulfonic acid.

A graft polymer is produced through an esterification reaction of polycarboxylic acid and polyoxyalkylene glycol according to the following reaction equation (3).

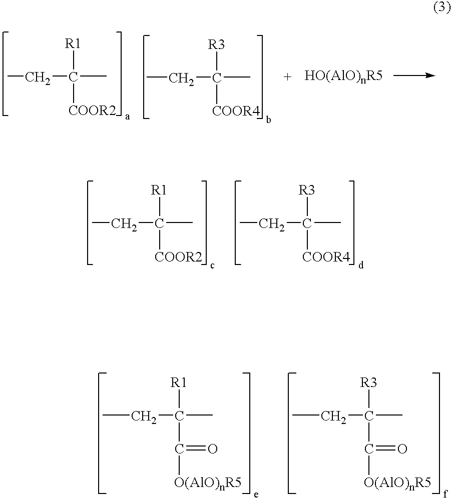

In the reaction equation (3), R₁ and R₃ respectively represent a hydrogen atom or a methyl group, and R₂ and R₄ respectively represent a hydrogen atom or a hydrocarbon group having 1 to 30 carbon atoms. Here, each of R₂ and R₄ preferably represents a hydrocarbon group having 1 to 6 carbon atoms and more preferably, is one of a methyl group, an ethyl group and a butyl group. At least one of R₂ and R₄ is the hydrogen atom. (-A1O—) represents an oxyalkylene unit having 2 to 4 carbon atoms and the (-A1O—) may have one kind of the oxyalkylene unit or may be a combination of two or more kinds of the oxyalkylene units, n represents an average molar number of the oxyalkylene unit and is an integer of 1 to 100, R₅ represents a hydrogen atom or a hydrocarbon group having 1 to 30 carbon atoms. a, b, c, d, e and f represent mol ratios of repeating unit constituting the polymer, the value of a+b is larger than 0, c+e=a, d+f=b, and the value of b is 0 to 0.5, and preferably is 0.05 to 0.3.

According to the present embodiment, a graft polymer having similar dispersing property with the water reducing agent obtained according to the conventional method may be produced.

Hereinafter, the method of preparing the graft polymer according to the present invention will be described in detail with reference to examples and comparative examples.

Preparing Ester-Based Graft Polymer

### EXAMPLE 1

First, polycarboxylic acid was polymerized. Into a 2-L glass reaction vessel equipped with a thermometer, a stirrer, a dropping funnel and a refluxing and cooling apparatus, were added 1405 parts by weight of methoxy polyoxyethylene glycol (average molar number of oxyethylene unit is 23 mols), 92 parts by weight of isopropyl alcohol, 1 part by weight of phenothiazine, 9 parts by weight of para-toluene sulfonic acid, and 1 part by weight of azobis isobutyronitrile and then, the mixture was stirred and heated to about 120° C. 202 parts by weight of acrylic acid and 6 parts by weight of azobis isobutyronitrile were dispersed and dissolved, then added drop by drop for 2 hours. After completing the dropping, 0.5 parts by weight of azobis isobutyronitrile was dispersed into 5 parts by weight of isopropyl alcohol. The reactant was aged to obtain polycarboxylic acid for about 30 minutes.

Subsequently, an esterification reaction was implemented to obtain an ester-based graft polymer. The esterification reaction was conducted for 16 hours while operating an aspirator vacuum apparatus and keeping the reaction temperature of about 130° C. to obtain an ester-based graft polymer having a melt viscosity of about 120 cps measured by a Brookfield viscometer at a temperature of about 80° C.

### EXAMPLES 2 TO 4 & EXAMPLES 7 TO 10

Ester-based graft polymers were produced by implementing the same procedure described in Example 1 except for adding 1.5 parts by weight of azobis isobutyronitrile as a polymerization catalyst based on monomer for polymerizing polycarboxylic acid, 1 part by weight of para-toluene sulfonic acid, based on polyoxyethylene glycol and 0.05 part by weight of phenothiazine as an antioxidant based on polyoxyethylene glycol, and implementing the esterification reaction after the polymerization at a temperature of 130° C. for 20 hours. Detailed polymerizing conditions for the examples 2 to 4 and 7 to 10 are illustrated in Table 1.

### EXAMPLES 5 AND 6

Ester-based graft polymers were produced by implementing the same procedure described in Example 1 except for keeping the pressure to about 2.5 atm during the polymerization using a 200-L pilot reaction vessel that can endure the pressure up to 5 atm. Detailed polymerizing conditions for the examples 5 and 6 are illustrated in Table 1.

TABLE 1

| | | | | | | | Polyoxyethylene | | | | | Polymerizing | | |
|---|---|---|---|---|---|---|---|---|---|---|---|---|---|---|
| | | | | | | | glycol | | | | | condition | | Molten |
| | Polycarboxylic acid polymer | | | | | | MPE | MPE | PEG | Solvent added | | Temp. | Press. | Viscosity |
| Exam. | A | MA | AM | AE | AB | MAM | 23 | 15 | 45 | IPA | TBA | (° C.) | (atm) | (cps) |
| 1 | 202 | | | | | | 1405 | | | 92 | | 120 | 1 | 120 |
| 2 | | 279 | | | | | 733 | | | | 15 | 160 | 1 | 8000 |
| 3 | | 271 | 115 | | | | 1003 | | | 52 | | 135 | 1 | 6900 |
| 4 | 184 | 183 | | | | | | 1062 | | | 20 | 160 | 1 | 980 |
| 5 | 10900 | 27100 | | | | | | 101400 | | 15000 | | 150 | 2.5 | 1400 |
| 6 | 4200 | 34300 | | | | | | 102300 | | 15000 | | 150 | 2.5 | 2600 |
| 7 | | 285 | | 101 | | | 1006 | | | 50 | | 135 | 1 | 6500 |
| 8 | | 295 | | | 91 | | 1004 | | | 50 | | 135 | 1 | 7300 |
| 9 | | 181 | | | | 179 | 1004 | | | 50 | | 135 | 1 | 7000 |
| 10 | | 372 | | | | | 1532 | | 40 | 50 | | 140 | 1 | 12500 |

In Table 1, A represents acrylic acid, MA represents methacrylic acid, AM represents methyl acrylate, AE represents ethyl acrylate, AB represents butyl acrylate, MAM represents methyl methacrylate, MPE23 represents methoxy polyoxyethylene glycol (average molar number of oxyethylene unit is 23 mols), MPE15 represents methoxy polyoxyethylene glycol (average molar number of oxyethylene unit is 15 mols), PEG45 represents polyoxyethylene glycol (average molar number of oxyethylene unit is 45 mols), IPA represents isopropyl alcohol, TBA represents tertiary butyl alcohol, exam. represents example, temp. represents temperature, and press. represents pressure. The unit for each component is parts by weight.

### COMPARATIVE EXAMPLE 1

Polyoxyethylene glycol ester monomer was prepared according to the conventional method. That is, into a 2-L glass reaction vessel provided with a thermometer, a stirrer, a Dean and Stark trap and a refluxing and cooling apparatus, were added 1000 parts by weight of methoxy polyoxyethylene glycol (average molar number of oxyethylene unit is 23 mols), 25 parts by weight of polyoxyethylene glycol (average molar number of oxyethylene unit is 45 mols), 215 parts by weight of methyl methacrylic acid, 350 parts by weight of toluene, 1 part by weight of phenothiazine and 9 parts by weight of para-toluene sulfonic acid. Then, the mixture was stirred and heated to carry out an esterification reaction at a refluxing temperature of toluene for 20 hours. Here, the refluxing temperature was about 124 to about 134° C. Then, toluene was removed through a vacuum evaporating process and the reactant was cooled to 80° C. or less. 300 parts by weight of 1% by weight of sodium hydroxide was added and then thus obtained mixture was vacuum evaporated to adjust the content of toluene to 100 ppm or less. Subsequently, the solid content was adjusted to 70% by weight to obtain about 1400 parts by weight of methacrylic acid polyoxyethylene glycol ester monomer having an acid value of 34.

After 400 parts by weight of distilled water was poured into a 2-L glass four-necked flask, the temperature was increased to about 75° C. Into a 2-L beaker, were added 100 parts by weight of distilled water, 1000 parts by weight of the above-obtained 70% methacrylic acid polyoxyethylene glycol ester monomer, 160 parts by weight of methacrylic acid and 12 parts by weight of 3-mercaptopropionic acid. The mixture was uniformly stirred and dissolved. Using 120 parts by weight of 10% by weight of aqueous ammonium persulfate solution as a polymerizing catalyst, a dropping polymerization reaction was conducted for 4 hours. However, water-insoluble gel starts to form after 2 hours from the initial time of the dropping polymerization reaction. Therefore, an ester-based graft polymer according to comparative example 1 was not obtainable.

Experiment for Determining Dispersing Property of Cement Slurry

Preparation of Aqueous Samples of Dispersing Agent

Aqueous Sample 1

200 parts by weight of the ester-based graft polymer prepared from the example 1 was continuously added into 20 parts by weight of alkaline aqueous diethanolamine solution and 280 parts by weight of distilled water. During adding, the aqueous solution was continuously stirred. The aqueous solution was then cooled to keep the temperature thereof to about 50° C. or lower and the ester-based graft polymer was homogeneously dissolved to prepare an aqueous sample of dispersing agent 1.

Aqueous Samples 2-10

Aqueous samples of dispersing agents 2 to 10 were prepared by implementing the same procedure described in the method of preparing the aqueous sample 1 except for the amount used of distilled water, the kind and amount of alkaline neutralizing component. Particular conditions for preparing the aqueous solutions of the dispersing agent and physical properties are illustrated in Table 2.

TABLE 2

| | | Alkaline neutralizing | | | Physical property of dispersing | | |
|---|---|---|---|---|---|---|---|
| | | component | | Used | agent sample (25° C.) | | |
| Aq. | | 50% | | polymer | Effective | | pH |
| Soln. | Distilled | sodium | Diethano- | from | compo. | Viscosity | (undiluted |
| sample | water | hydroxide | lamine | example | (%) | (cps) | solution) |
| 1 | 280 | — | 20 | 1 | 40 | 30 | 6.9 |
| 2 | 268 | 32 | — | 2 | 40 | 380 | 6.8 |
| 3 | 176 | 24 | — | 3 | 50 | 940 | 7.1 |
| 4 | 200 | — | — | 4 | 50 | 90 | 2.5 |
| 5 | 200 | — | — | 5 | 50 | 230 | 2.6 |
| 6 | 200 | — | — | 6 | 50 | 440 | 2.6 |
| 7 | 178 | 22 | — | 7 | 50 | 870 | 6.9 |
| 8 | 178 | 22 | — | 8 | 50 | 900 | 6.5 |
| 9 | 198 | 12 | — | 9 | 50 | 1100 | 7.2 |
| 10 | 180 | 20 | — | 10 | 50 | 1040 | 6.7 |

In the table 2, Aq. Soln. sample represents aqueous solution sample, effective compo. represents effective component and the unit of each component is parts by weight.

Comparative Aqueous Solution Sample 1

Commonly available aqueous sample of a dispersing agent was prepared. That is, CP-WR (trade name of PC-based (polycarboxylate-based) water reducing agent manufactured by LG Chemical Co., Ltd. in Korea) was prepared.

Comparative Aqueous Solution Sample 2

Commonly available aqueous sample of a dispersing agent was prepared. That is, CP-WB (trade name of PC-based water reducing agent manufactured by LG Chemical Co., Ltd. in Korea) was prepared.

83 parts by weight of the aqueous samples 1 to 10 and comparative aqueous samples 1 and 2 based on 1.5% by weight of effective component were taken into a 200-mL glass sample bottle. 250 parts by weight of ordinary portland cement (manufactured by Hanil Cement Co., Ltd. In Korea) was added and pre-mixed using a hand. The mixture was stirred using a laboratory high-speed stirrer by 3000 times/min for 3 minutes until the mixture became uniform. The viscosity was measured using a Brookfield viscometer. Here, the measuring time was 30 seconds after starting the operation of the Brookfield viscometer. After the cement slurry was stood in an incubator at a room temperature of 10° C. for 60 minutes, and the cement slurry was stirred by 3000 times/min using the laboratory high-speed stirrer for 1 minute. The viscosity of the slurry was measured using the Brookfield viscometer. The results are illustrated in Table 3.

TABLE 3

| | | | Slurry |
|---|---|---|---|
| | Slurry viscosity after | Standing | viscosity after |
| | dispersing (cps) | temp. (° C.) | 60 min. (cps) |
| aq sample 1 | 1500 | 10 | 1800 |
| aq sample 2 | 620 | 25-30 | 1420 |
| aq sample 3 | 305 | 25-30 | 1180 |
| aq sample 4 | 400 | 10 | 840 |
| aq sample 5 | 455 | 10 | 900 |
| aq sample 6 | 390 | 10 | 780 |
| aq sample 7 | 480 | 25-30 | 960 |
| aq sample 8 | 560 | 25-30 | 1140 |
| aq sample 9 | 360 | 25-30 | 1080 |
| aq sample 10 | 1160 | 25-30 | 3500 |
| Comparative | 345 | 25-30 | 1220 |
| aq sample 1 | | | |
| Comparative | 520 | 25-30 | 1140 |
| aq sample 2 | | | |

In the Table 3, aq sample represents aqueous sample, standing temp. represents standing temperature and 60 min. represents 60 minutes.

Referring to Table 3, the cement slurries of the comparative aqueous sample 1 and the comparative aqueous sample 2 exhibit almost similar dispersing property with those of the aqueous samples 1 to 10 according to the present invention. That is, the cement slurry of the comparative aqueous sample 1 exhibits almost similar dispersing property with that of the aqueous sample 3 and the cement slurry of the comparative aqueous sample 2 exhibits almost similar dispersing property with that of the aqueous sample 8.

Therefore, when a cement slurry is manufactured using the graft polymer prepared by the method of preparing the graft polymer of the present invention, almost equal dispersing property is obtainable with the cement slurry manufactured by the conventional method including the conventional water reducing agent, while minimizing an effect due to the quality of raw material monomer.

According to the present invention, polycarboxylic acid is prepared in advance and subsequently a graft polymer is prepared through an esterification reaction of polycarboxylic acid and polyoxyalkylene glycol. Accordingly, when comparing with a conventional method of preparing a water reducing agent from an ester-based graft monomer with unsaturated carboxylic acid, the quality change of the graft polymer due to the raw material change may be minimized in the present invention. Cement slurry having similar dispersing property with the conventional cement slurry may be manufactured using the graft polymer prepared according to the present invention. Further, a graft polymer having a good dispersing property can be prepared economically.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A graft polymer represented by a chemical formula (1): 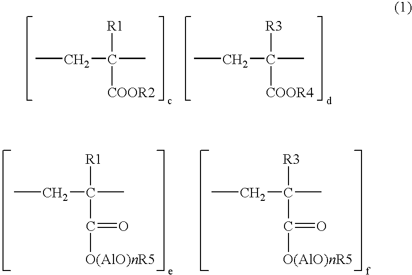
wherein R₁ and R₃ independently represent a hydrogen atom or a methyl group, R₂ and R₄ independently represent a hydrogen atom or a hydrocarbon group having 1 to 30 carbon atoms, at least one of R₂ and R₄ being the hydrogen atom, (-A1O—) represents an oxyalkylene unit having 2 to 4 carbon atoms, (-A1O—) having one kind of the oxyalkylene unit, or being a combination of two or more kinds of the oxyalkylene units, n represents an average molar number of the oxyalkylene unit and is an integer of 1 to 100, R₅ represents a hydrogen atom or a hydrocarbon group having 1 to 30 carbon atoms, and c, d, e and f represent mol ratios of repeating unit constituting the graft polymer, a value of c+d+e+f being larger than 0 and a value of d+f being 0 to 0.5.

2. The graft polymer of claim 1, wherein the graft polymer has a melt viscosity of about 100 cps to about 50000 cps at a temperature of about 80° C.

3. The graft polymer of claim 1, wherein the value of d+f in the chemical formula (1) is in a range of about 0.05 to about 0.3.

4. The graft polymer of claim 1, wherein R₂ and R₄ independently represent one of a methyl group, an ethyl group and a butyl group.

5. A method of preparing a graft polymer comprising a step of conducting an esterification reaction of polycarboxylic acid and polyoxyalkylene glycol.

6. The method of claim 5, wherein the polycarboxylic acid is prepared by polymerizing an unsaturated carboxylic acid.

7. The method of claim 6, wherein the preparing of the polycarboxylic acid is implemented according to the following reaction equation (2): 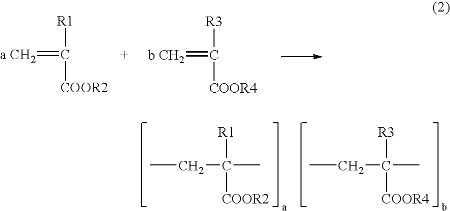
wherein R₁ and R₃ independently represent a hydrogen atom or a methyl group, R₂ and R₄ independently represent a hydrogen atom or a hydrocarbon group having 1 to 30 carbon atoms, at least one of R₂ and R₄ being the hydrogen atom, a and b represent mol ratios of repeating unit constituting the polymer, value of a+b is larger than about 0 and value of b is about 0 to about 0.5.

8. The method of claim 7, wherein the R₂ and R₄ independently represent a methyl group, an ethyl group or a butyl group.

9. The method of claim 6, wherein the preparing of the polycarboxylic acid is implemented at a temperature of about 80° C. to about 170° C.

10. The method of claim 6, wherein the preparing of the polycarboxylic acid is implemented at a pressure of about 5 atm or less.

11. The method of claim 6, wherein the preparing of the polycarboxylic acid is implemented in the presence of an esterification acid catalyst, and the preparing of the polycarboxylic acid and the esterification reaction of the polycarboxylic acid and the polyoxyalkylene glycol are simultaneously carried out.

12. The method of claim 6, wherein 0 to 20% by weight of a polymerizing solvent selected from the group consisting of isopropyl alcohol and tertiary butyl alcohol based on the weight amount of the polyoxyalkylene glycol is used during preparing the polycarboxylic acid.

13. The method of claim 6, wherein the preparing of the polycarboxylic acid is implemented in the presence of an azo-based catalyst.

14. The method of claim 5, wherein the preparing of the graft polymer is conducted according to the following reaction equation (3): 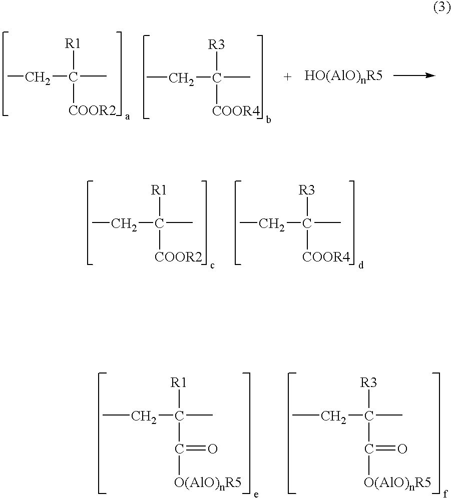
wherein R₁ and R₃ independently represent a hydrogen atom or a methyl group, R₂ and R₄ independently represent a hydrogen atom or a hydrocarbon group having 1 to 30 carbon atoms, at least one of R₂ and R₄ being the hydrogen atom, (-A1O—) represents an oxyalkylene unit having 2 to 4 carbon atoms, the (-A1O—) having one kind of the oxyalkylene unit or being a combination of two or more kinds of the oxyalkylene units, n represents an average molar number of the oxyalkylene unit and is an integer of 1 to 100, R₅ represents a hydrogen atom or a hydrocarbon group having 1 to 30 carbon atoms, a, b, c, d, e and f represent mol ratios of repeating unit constituting the polymer, the value of a+b is larger than about 0, c+e=a, d+f=b, and the value of b is about 0 to about 0.5.

15. The method of claim 5, wherein the preparing of the graft polymer is implemented at a temperature of about 80° C. to about 150° C.

16. The method of claim 5, wherein the preparing of the graft polymer is implemented in the presence of an ester acid catalyst.

17. The method of claim 16, wherein the acid catalyst comprises para-toluene sulfonic acid.

18. The method of claim 5, wherein the esterification reaction is conducted until a melt viscosity of the graft polymer is in a range of about 100 cps to about 50000 cps at a temperature of about 80° C.

19. The method of claim 5, wherein a vacuum dehydration reaction is further implemented during conducting the esterification reaction for the preparation of the graft polymer, simultaneously.
